(19) United States
(12) Patent Application Publication
(10) Pub. No.: US 2013/0168595 A1
(43) Pub. Date: Jul. 4, 2013

(54) NANOMETER THERMAL INSULATION COATING AND METHOD OF MANUFACTURING THE SAME

(71) Applicant: Keith Chang, Richardson, TX (US)

(72) Inventor: Keith Chang, Richardson, TX (US)

(21) Appl. No.: 13/339,977

(22) Filed: Dec. 29, 2011

(51) Int. Cl. C09K 3/00; B82Y 40/00; B82Y 30/00

(52) U.S. Cl. 252/62; 977/773; 977/900

(57) ABSTRACT

A nanometer thermal insulation coating and a method of manufacturing the same is disclosed. The method includes the steps of : mixing and stirring nanometer metal oxide and stirring-assistant liquid to form the mixed paste; filtering and drying the mixed paste to form the dried mixed bulk; performing calcination to the dried mixed bulk to form the oxide solid solution bulk of antimony tin oxide/silicon oxide and/or vanadium dioxide/silicon oxide; adding dispersing-assistant liquid, mixing and sequentially mechanical stirring, performing ultrasonic resonance and high pressure homogenizing to form the elementary dispersion bulk; and adding mixing-assistant liquid, mixing and sequentially steps of mechanical stirring and high pressure homogenizing to form nanometer thermal insulation coating, suitable to apply on the glass to achieve the feature of thermal insulation.

### BACKGROUND OF THE INVENTION

1. Field of the Invention

The present invention generally relates to a nanometer thermal insulation coating and a method of manufacturing the same, and more specifically to a hybrid solid solution with nanometer antimony tin oxide and nanometer vanadium oxide.

2. The Prior Arts

Recently, many modern buildings have been erected in cities as worldwide economy developed. The indoor temperature of the buildings usually increases because of thermal radiation from the sunlight easily passing through the glass windows and transparent roofs of the buildings such that air conditioners becomes more frequently used with a result of high power consumption. According to the statistic data from United States Department of Energy, approximately 30-50% of the capability of cooling provided by the air conditioner is consumed due to the solar energy through the windows. Additionally, ultraviolet in the sunlight accelerates the aging of the furniture and staffs in the buildings, and possibly even causes serious damage to human body.

For the problems which results from the thermal radiation of the sunlight, one of the traditional solutions is to use specific glass with some thermal reflective metallic coatings and/or many kinds of thermal reflective film in order to achieve the purpose of cooling by retarding or reducing heat flow. However, the above solution leads to other issues, such as less ideal transparency and higher cost of manufacturing.

Currently, some kinds of transparent thermal insulation coating with better transparency and thermal insulation have been studied and developed, such as thermal insulation coatings with nanometer ITO (Indium Tin Oxide), which can improve the capability of thermal insulation for the glass as well as maintain some desired level of transparency. Such thermal coatings provide higher shielding effect for infrared light and better transparency, and have been successfully employed in many applications. However, nanometer ITO costs much and hard to be widespread.

Furthermore, some studies about additionally adding hollow micro beads and nanometer coating particles even with less heat conductivity prove better reflectivity for ultraviolet and near infrared, resulting in better thermal insulation. But the transparency of the resultant coating does not meet what required because of the opacity of the hollow micro beads. Therefore, it is thus greatly desired to have a thermal insulation coating with better wear-resisting, weather-resisting and self-cleaning as well as some level of shielding effect and reflectivity for ultraviolet and infrared so as to solve the above problems in the prior arts by insulating part of the heat from the sunlight via thermal radiation.

### SUMMARY OF THE INVENTION

A primary objective of the present invention is to provide a nanometer thermal insulation coating, which primarily comprises an elementary dispersion bulk, a polymer lotion and a coating-assistant agent. The elementary dispersion bulk consists of oxide solid solution, nanometer metal substance, water, alcohol and dispersion agent. The oxide solid solution is modified and may comprise antimony tin oxide/silicon oxide and/or vanadium dioxide/silicon oxide.

As disclosed in many literatures, some nanometer oxides and metal substance particles, such as vanadium dioxide, aluminum oxide, silicone oxide, titanium oxide, zinc oxide, cerium oxide, iron oxide, tin oxide doped with antimony, nickel, silver, and aluminum, indeed provide some shielding effect and reflectivity for ultraviolet and near infrared. Therefore, part of thermal heat from the sunlight can be effectively insulated.

Moreover, nanometer particles can enhance wear-resisting, weather-resisting and self-cleaning for the layer of the coating. It is needed to add the nanometer oxides and metal substance to the thermal insulation coating with appropriate mixing ratio, which can be applied on the glass to obtain superior transparency, high thermal insulation and excellent hybrid features.

Another objective of the present invention is to provide a method of manufacturing nanometer thermal insulation coating, which comprises the steps of:

mixing and stirring nanometer antimony tin oxide (ATO), nanometer vanadium oxide (VO₂), TEOS (Tetraethyl Orthosilicate), ammonia water, de-ionized water, waterless ethanol and surfactant to form a mixed paste;

filtering and drying the mixed paste to form a dried mixed bulk;

performing calcination to form an oxide solid solution bulk with nanometer level modification, comprising antimony tin oxide/silicon oxide (ATO/SiO₂ solid solution and/or vanadium dioxide/silicon oxide (VO₂/SiO₂) solid solution;

mixing the oxide solid solution, nanometer metal substance, water, alcohol and dispersion agent, and sequentially performing the processes of mechanic stirring, ultrasonic resonance and high pressure homogenizing to form an elementary dispersion bulk; and

mixing the elementary dispersion bulk, polymer lotion and coating-assistant agent, and sequentially performing the processes of mechanic stirring and high pressure homogenizing to form the nanometer thermal insulation coating.

### BRIEF DESCRIPTION OF THE DRAWINGS

The present invention can be understood in more detail by reading the subsequent detailed description in conjunction with the examples and references made to the accompanying drawings, wherein:

FIG. 1 is a flow chart to illustrate the processes of the method according to the present invention.

### DETAILED DESCRIPTION OF THE PREFERRED EMBODIMENT

The present invention may be embodied in various forms and the details of the preferred embodiments of the present invention will be described in the subsequent content with reference to the accompanying drawings. The drawings (not to scale) show and depict only the preferred embodiments of the invention and shall not be considered as limitations to the scope of the present invention. Modifications of the shape of the present invention shall too be considered to be within the spirit of the present invention.

The nanometer thermal insulation coating of the present invention comprises an elementary dispersion bulk and a mixing-assistant liquid. The elementary dispersion bulk may comprise oxide solid solution bulk, nanometer metal substance and dispersing-assistant liquid. The oxide solid solution bulk may comprise antimony tin oxide/silicon oxide (ATO/SiO₂) solid solution and/or vanadium dioxide/silicon oxide (VO₂/SiO₂) solid solution. The mixing-assistant liquid comprises polymer lotion and coating-assistant agent.

The dispersing-assistant liquid comprises water, alcohol and dispersion agent. The nanometer metal substance comprises at least one of nanometer nickel, nanometer silver and nanometer aluminum with an average diameter of 30-60 nm.

A molar ratio for antimony tin oxide/silicon oxide and vanadium dioxide/silicon oxide in the oxide solid solution bulk is between 70:30 and 90:10.

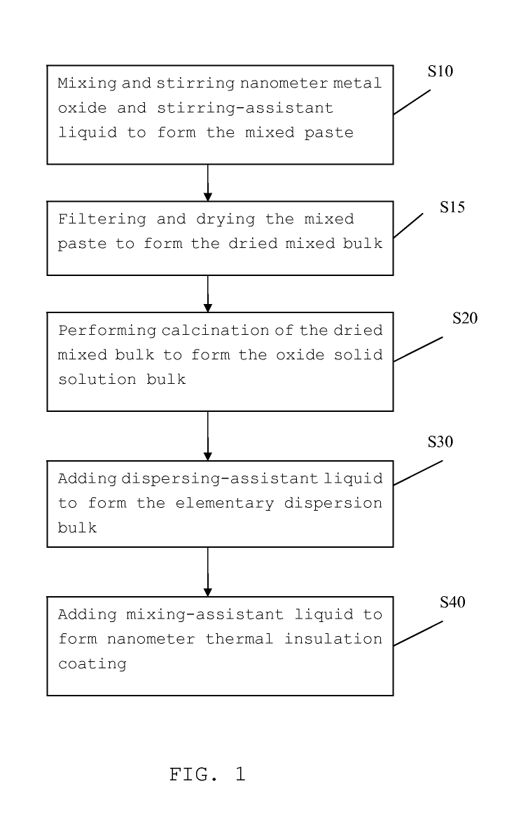

Please refer to FIG. 1. As shown in FIG. 1, the flow chart schematically illustrating the processes of the method according to the present invention comprises the steps S10, S20, S30 and S40, sequentially performed to generate the nanometer thermal insulation coating.

First, the method of the present invention starts at step S10 by mixing and stirring nanometer metal oxide and stirring-assistant liquid for 20 minutes to one hour to form a mixed paste. The nanometer metal oxide primarily comprises nanometer antimony tin oxide and nanometer vanadium dioxide. The stirring-assistant liquid is generated by mixing TEOS (Tetraethyl Orthosilicate), ammonia water, de-ionized water, waterless ethanol and a surfactant under an reaction in 30-80° C. for 20 minutes to 1 hour. Also, the surfactant may comprise polyvinyl pyrrolidone, polyethylene glycol or carboxylate.

Then, the mixed paste is filtered and dried to form a dried mixed bulk in the step S15, and later, in the step S20, the calcination of the dried mixed bulk is performed under calcination temperature for 5 to 8 hours to form an oxide solid solution bulk. The calcination temperature is about 600-1000° C., and the oxide solid solution bulk may comprise antimony tin oxide/silicon oxide solid solution and/or vanadium dioxide/silicon oxide solid solution.

Next, in the step S30, nanometer metal substance and dispersing-assistant liquid are added to the oxide solid solution bulk, followed by sufficiently mixing. The steps of mechanical stirring, ultrasonic resonance and high pressure homogenizing are sequentially performed to form an elementary dispersion bulk. The dispersing-assistant liquid may comprise water, alcohol and dispersion agent.

The nanometer metal substance comprises at least one of nanometer nickel, nanometer silver and nanometer aluminum with an average diameter of 30-60 nm

Finally, in the step 40, the elementary dispersion bulk is added and mixed with mixing-assistant liquid by sequentially performing the steps of mechanical stifling and high pressure homogenizing to form the nanometer thermal insulation coating. The mixing-assistant liquid may comprise polymer lotion and coating-assistant agent and the high pressure homogenizing is operated under a pressure of 100-150 MPa.

The above nanometer antimony tin oxide, nanometer vanadium oxide, TEOS, ammonia water, de-ionized water, waterless ethanol and surfactant are configured by molar ratios as 70-90, 10-30, 0.5-3, 0.1-1.8, 2-8, 15-90 and 0.06-0.20, respectively.

A key feature of the present invention is the nanometer thermal insulation coating can be applied on the glass or other substrates to form a layer of film with superior transparency and excellent thermal insulation. Especially used in building materials, the film can effectively maintain the indoor temperature and block or reduce the influence by the environment temperature so as to achieve the object of environment protection and energy conservation. Thus, the nanometer thermal insulation coating according to the present invention is a new material for environment protection and energy conservation.

Another feature of the present invention is the nanometer thermal insulation coating can be manufactured at lower material cost by simpler processes. Especially, the nanometer thermal insulation coating can be applied on the large substrate by traditional coating process such as brushing or spraying for paint, to a film of thermal insulation coating with uniform thickness, which is long life, stable and easy to maintain, and further obtains economic and society benefits resulting from environment protection and energy conservation.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A nanometer thermal insulation coating, comprising an elementary dispersion bulk and a mixing-assistant liquid, wherein
said elementary dispersion bulk comprises oxide solid solution bulk, nanometer metal substance and dispersing-assistant liquid, and said oxide solid solution bulk comprises antimony tin oxide/silicon oxide and/or vanadium dioxide/silicon oxide; and
said mixing-assistant liquid comprises polymer lotion and coating-assistant agent.

2. The nanometer thermal insulation coating as claimed in claim 1, wherein said dispersing-assistant liquid comprises water, alcohol and dispersion agent.

3. The nanometer thermal insulation coating as claimed in claim 1, wherein said nanometer metal substance comprises at least one of nanometer nickel, nanometer silver and nanometer aluminum with an average diameter of 30-60 nm.

4. The nanometer thermal insulation coating as claimed in claim 1, wherein said antimony tin oxide/silicon oxide and vanadium dioxide/silicon oxide in said oxide solid solution bulk have a molar ratio between 70:30 and 90:10.

5. A method of manufacturing nanometer thermal insulation coating, comprising the steps of:
mixing and stirring nanometer metal oxide and stirring-assistant liquid for 20 minutes to one hour to form a mixed paste, wherein said nanometer metal oxide comprises nanometer antimony tin oxide and nanometer vanadium oxide;
filtering and drying said mixed paste to form a dried mixed bulk;
performing calcination of said dried mixed bulk under calcination temperature for 5 to 8 hours to form an oxide solid solution bulk, wherein said oxide solid solution bulk comprises antimony tin oxide/silicon oxide solid solution and/or vanadium dioxide/silicon oxide solid solution;
adding nanometer metal substance and dispersing-assistant liquid into said oxide solid solution bulk, mixing and sequentially performing steps of mechanical stirring, ultrasonic resonance and high pressure homogenizing to form an elementary dispersion bulk; and
adding mixing-assistant liquid into said elementary dispersion bulk, mixing and sequentially performing steps of mechanical stirring and high pressure homogenizing to form nanometer thermal insulation coating.

6. The method as claimed in claim 5, wherein
said stirring-assistant liquid is generated by mixing TEOS (Tetraethyl Orthosilicate), ammonia water, de-ionized water, waterless ethanol and a surfactant, and performing reaction under 30-80° C. for 20 minutes to 1 hour;
said dispersing-assistant liquid comprises water, alcohol and dispersion agent; and
said mixing-assistant liquid comprises polymer lotion and coating-assistant agent.

7. The method as claimed in claim 6, wherein said nanometer antimony tin oxide, nanometer vanadium oxide, TEOS, ammonia water, de-ionized water, waterless ethanol and surfactant have molar ratios as 70-90, 10-30, 0.5-3, 0.1-1.8, 2-8, 15-90 and 0.06-0.20, respectively, and said surfactant comprises polyvinyl pyrrolidone, polyethylene glycol or carboxylate, and said nanometer metal substance comprises at least one of nanometer nickel, nanometer silver and nanometer aluminum with an average diameter of 30-60 nm.

8. The method as claimed in claim 5, wherein said calicination temperature is within 600-1000° C., and said high pressure homogenizing is performed under a pressure of 100-150 MPa.
